(19) United States
(12) Patent Application Publication
(10) Pub. No.: US 2021/0176957 A1
(43) Pub. Date: Jun. 17, 2021

(54) APPARATUS FOR AUTOMATIC PROVISIONING OF WET FOOD FOR PETS

(71) Applicant: Benjamin LIST, Tuebingen (DE)

(72) Inventor: Benjamin LIST, Tuebingen (DE)

(21) Appl. No.: 16/950,166

(22) Filed: Nov. 17, 2020

(30) Foreign Application Priority Data
Dec. 16, 2019 (DE) 10 2019 134 550.2
Aug. 31, 2020 (EP) 20193528.5

(51) Int. Cl. A01K 5/02

(52) U.S. Cl. CPC A01K 5/0216; A23K 50/48; A01K 5/0291

(57) ABSTRACT

An automatic feeding device allows automated access by a pet to wet food based on specific criteria, such as a lapsed time, so the pet is taken care of during of an extended absence of the pet owner. The apparatus has at least one holder that stores portion containers containing the wet food which are then opened as needed. In one aspect, the automatic feeding device transfers a cut-off lid using a gripping element having two clamping jaws that can be moved relative to one another for gripping a tear tab formed on a lid of the portion container. The gripping element is accommodated on a carriage which can be moved on a rail arrangement that traverses the portion container to be opened. Alternatively, an endless punching knife has a blade for punching a portion container lid and the holder has a retrieval device for retrieving the separated lid.

### CROSS REFERENCE TO RELATED APPLICATIONS

Applicant claims priority under 35 U.S.C. § 119 of German Application No. 10 2019 134 550.2 filed on Dec. 16, 2019 and European Application No. 20193528.5 filed Aug. 31, 2020, the disclosures of which are incorporated by reference.

### BACKGROUND OF THE INVENTION

### 1. Field of the Invention

The present invention relates to an apparatus for automatic provisioning of wet food for pets, comprising at least one holder for storage, preferably shape-fit storage of a portion container containing wet food, and means for automatic opening of a portion container situated in the at least one holder.

### 2. Description of the Related Art

Such an apparatus is already known from DE 37 44 337 A1. It provides for interplay of two carousels, in the case of which a first carousel has a plurality of liquid containers, whereas a second carousel has a plurality of portion containers containing food. The time point of provisioning of a new portion container and a new liquid container is established by way of a time function. When such a time point is reached, the carousels rotate by one position of rotation, wherein the next container that is in position is opened, in each instance. Opening of the container takes place according to the principle of a can opener, in that a blade is driven through the lid into the interior of the corresponding container, and the container is rotated in a circle. The lid is grasped by a deflector and conveyed to the outside by way of a slot in the lid of the housing above the carousel. Then the opened containers are brought into a position of rotation at which a pet is given access to the contents of the container through a retrieval opening. It is understood that the design and placement of the apparatus allows access for a pet, for example a dog or a cat. The construction is correspondingly flat and allows access to the interior of the portion container over the largest possible area, so that the pet can reach the food with its tongue until all of it is consumed.

This design, however, possesses some disadvantages. For example, during the process of cutting according to the principle of a can opener, at first a sharp edge is formed on the containers, on which the pet can cut itself. A sharp edge also is formed on the lid, which is furthermore conveyed out of the device and thereupon lies on it or next to it, and thereby within the reach of the animal. The animal can lick the lid, for one thing, in order to reach bits of food that remain on it, but can also carry the lid away and leave it lying in the home, where it might not be found until much later.

In particular, however, the apparatus works only with round containers, because only round containers can be opened using the technique described, according to the principle of a can opener. The round shape, however, is only one possible shape for pet food, and actually a rather unusual shape for portion containers. Cat food, in particular, is frequently offered for sale in square bowls made of aluminum foil, or, depending on the vendor, also in octagonal bowls, the lid of which also hardly ever has the required rigidity so that it can be conveyed out using this apparatus from the state of the art.

A further known apparatus is described in FR 2 629 810 A1. Here is provided a row of cans, which possess a sheet-metal lid having a tear tab. These cans are managed with a lever mechanism, so that the next container, in each instance, is automatically pulled open at an established point in time and is available to the animal. This apparatus, however, has the disadvantage that here, too, the lid projects away and represents an injury hazard; furthermore, the container remains available until it is removed manually, with the effect that here, too, the animal can access old wet food that has been left standing. This food, however, might have already spoiled because it is stored in the open. Furthermore, the odor burden resulting from an increasing number of open containers is high.

Furthermore, carousel apparatuses in which the work is performed either with individual containers, in other words transferring the wet food into the special containers of the apparatus must first take place, or in the case of which apparatuses fundamentally containers that are already open are used, because only dry food is made available, are also known in numerous versions in the state of the art. This arrangement particularly relates to the documents U.S. Pat. Nos. 4,248,175 A, 3,935,837 A, 4,421,059 A, and 5,078,097 A, as well as FR 2 616 621 A1 and FR 2 584 208 A1.

It is an advantage of carousel apparatuses, in particular, that they have a clear construction and that any food that has not been consumed by the time more food is dispensed is taken away from the animal again. It is problematic, however, that for this purpose, first either refilling into other containers and open storage within the carousel are required, or that the container is made available with a sharp edge and with an ejected lid.

### SUMMARY OF THE INVENTION

Against this background, the present invention is based on the task of proposing an apparatus for automatic provisioning of wet food for pets, which allows the use of unopened portion containers but avoids the formation of accessible sharp edges, and removes a lid that has been cut off from access by the pet.

These and other tasks are accomplished by means of apparatuses for automatic provisioning of wet food for pets in accordance with different aspects of the invention. Practical further developments of such apparatuses can be derived below.

According to the invention, it is envisaged to provide one or more holders that can each carry a closed portion container containing wet food. Fundamentally, the invention comprises the use of portion containers containing any form of pet food, but it will be assumed in the following, for simplification, that essentially wet food in closed portion containers is offered. On the basis of a predetermined or adjustable time function, which is viewed as being given within the scope of the present invention, a control unit that is not described in any detail here and is insignificant for the function of the invention activates the apparatus at given times, so that a portion container is made available in opened manner, in each instance.

First of all, the invention distinguishes between two alternative embodiments, in which the lid of the portion container is pulled off, on the one hand, in a movement sequence as would also be performed manually by a person, and on the other hand, the lid is opened up and only a lid part is removed, but this removal is sufficient to make the portion container available.

First of all, the first alternative will be considered in the following, according to which the lid of the portion container is pulled off. For this purpose, the invention provides means for automatic opening of the portion container, which are structured as a gripping element. The means are two clamping jaws that can be moved relative to one another, which are suitable for grasping a tear tab, as this tab is formed on commercially conventional portion containers. The gripping element is arranged on a carriage, which can traverse the portion container to be opened, in its entirety, in that it can be moved on a rail arrangement.

First of all, a portion container is in engagement with the gripping element as a starting point, in this connection. The clamping jaws of the gripping element are open, at first, and approach the tear tab in such a manner that the tear tab gets between the two clamping jaws as the gripping element approaches. During the course of the further approach, the clamping jaws close, in that they move toward one another until contact occurs, and clamp the tear tab between them. Now the carriage crosses the portion container with the clamping jaws pressed against one another in this manner and pulls the lid off from the portion container behind it. The open bowl of the portion container can subsequently be accessed by the pet.

In a concrete embodiment of the gripping element, a first clamping jaw can be connected with the carriage in torque-proof manner and, in this connection, form a counter-bearing. Height adjustment or longitudinal adjustment on the carriage, however, is nevertheless possible also for the first clamping jaw. The second clamping jaw can then be mounted against this first, torque-proof clamping jaw, in movable manner, in particular so as to pivot, in that it is attached by being articulated on about an axis and is moved in the direction of the closed position, using at least one activation element, between a closed position and an open position, preferably by means of an activation element, and is moved in the direction of the open position using reset means, in particular a tension spring or a pressure spring.

Furthermore, it can be practical if the gripping element as a whole is mounted on the carriage in height-adjustable manner. It can be ensured by means of a superimposed lift while crossing the portion container that the pulled-off lid does not touch any other parts of the carriage, which thereby might cause wet food residues that might be adhering to the inside of the lid to adhere to these parts.

Control of the corresponding position of the gripping element as well as of its open or closed position can be influenced using a motion link controller, if necessary, so that purely position-dependent activation and movement of the gripping element can take place. This arrangement has the advantage that little effort is required for determining the position of the carriage and of the gripping element, and nevertheless suitable control is guaranteed.

In this regard, it is possible to activate the cam that has already been mentioned as a possible activation means for the gripping element, using a motor. The cam is essentially an element having an axis of rotation that is arranged outside of the center, so that its outer contour can deflect an adjacent component, such as here, the second clamping jaw of the gripping element, to different degrees, depending on the rotational position. Therefore, by means of rotation of the cam, in particular if the cam preferably has a circular or elliptical outer contour, a degree of deflection that continuously increases and then decreases again after a maximum can therefore be achieved.

It is advantageous if the cam is furthermore placed in such a manner that the gripping element is completely closed precisely at the point where the cam has reached its vertex, so that the cam can rotate completely about its cam axis. This arrangement can be of particular interest if the cam is connected with a gear wheel so as to act with it, which gear wheel interacts with a rack in the movement direction of the carriage. Such a rack can have teeth continuously or only in certain sections, depending on the desired movement progression, and can also allow position control in this manner.

The carriage can furthermore have a first roller element assigned to it, which leads in the movement direction. This element reaches the portion container even before the gripping element does, and presses the container into the holder, so that the gripping element does not lift the portion container during the course of pulling off the lid, which would prevent the lid from loosening any further.

A second roller element can furthermore be provided as a trailing roller element, so as to continue to hold the portion container down, so that the portion container always remains in a defined position.

As an alternative to a second, trailing roller element, however, an arrangement of releasable clamping elements can also be provided on both sides around the portion container, which elements hold the portion container down while the lid is being pulled off. In this way, it is possible to do without at least the trailing second roller element.

Such clamping elements can be structured, in particular, as oblong clamping tabs, which are attached at one end so as to rotate, next to the holder for the portion container, while they are held in a motion link guide at the other end, and can move in this guide between a release position and a clamping position, essentially toward the holder and away from it.

Of course, the clamping tabs can be manually put into the clamping position directly during the filling process of the apparatus. The carriage, however, can also have deflector elements, which press the clamping tabs into their clamping position along their motion link guide as the carriage traverses the portion container. For this purpose, the clamping tabs can be activated using a toggle guided in the motion link, in each instance, which toggle bumps up against the corresponding deflector element and is pushed into the clamping position by it. To particular advantage, such an arrangement of deflector elements can be situated on a front side and a back side of the carriage, so that the carriage can activate the clamping tabs during a forward movement and also during a reverse movement. In this manner, it can be ensured that the clamping elements lie in a defined position with reference to the carriage. Supplementally, the clamping tabs can be reset to the release position using spring elements, so that the user will always find an open holder and only has to lay the portion container into it.

The target of the carriage traversing the portion container is, to particular advantage, a waste container that is also placed in the region of the rail arrangement. A lid of a portion container that has been pulled off by the gripping element can be released when the waste container is reached and deposited in the waste container.

In the following, the second alternative will also be discussed, in which opening of the upcoming portion container takes place either using a laser cutting apparatus or using a punching knife, which latter item replicates the desired contour of the lid to be removed, in a closed, circulating, in other words endless form. Of these possibilities, the punching knife solution will be primarily considered in greater detail in the following.

The portion container is freed of the lid using means for removing the lid that has been separated from the container, referred to hereinafter as a lid part. Subsequently, the opened and uncovered portion container is made available to the pet.

By means of opening the portion container using a punching knife, it is ensured that the sharp edges known from can openers do not occur at the edge of the portion container; instead, these edges are at most bent downward slightly during punching, and are thereby kept away from the animal. Due to separate covering of the portion container, however, the apparatus retains control over the whereabouts of the lid part in particular, so that the lid part does not remain accessible in uncontrolled manner and is not left to the animal. Also, the invention provides for a separate blade for each portion container in the case of multiple holders, so that when opening the portion container, it is always possible to work with a fresh and hygienically perfect blade.

A punching press is situated on the holder or, in the case of multiple holders, if applicable, centrally at an opening position, and this punching press is used to release the lid from the portion container. This punching press can contain the punching knife directly. The invention, however, also provides for a further, advantageous solution, in which a separate set-down part is releasably assigned to each holder. This set-down part is set down onto the edge of the holder after a portion container has been placed in a holder and comprises a spring frame on which the punching knife is resiliently mounted. The portion containers can thereby always be opened with a fresh punching knife, while the punching press requires only one pressure element that activates the punching knife mounted on the set-down parts. By means of such activation, the punching knife is brought from a rest position into an opening position, in which it passes through the lid of the portion container and shears off the lid part. Because a punching knife is provided for each holder, it is also ensured that the lid part is not raised by the punching press, which would cause it to remain adhering to the punching knife in uncontrolled manner.

To further secure the cut edge that is formed, and also so as to always keep the punching knife itself away from access by the pet, an internal circumferential shield can be assigned to the set-down part, which completely covers the blade of the punching knife in the rest position, but exposes it at least partially in an opening position. In this way, the punching knife is moved out from behind the shield by means of the pressing element of the punching press, and subsequently disappears behind it again, away from access by the pet.

In detail, the blade of the punching knife can consist of tips spaced apart from one another, which are distributed over the circumferential blade of the punching knife and penetrate into the portion container first. Concave blade sections can then be provided in the interstices between these tips, which sections cleanly and reliably cut off the lid of the portion container as they penetrate further. The blade can preferably consist of plastic, stainless steel or ceramic, without any restriction to these materials.

The punching press provided at the opening position for activation of the punching knife is preferably set up for activating the punching knife of the corresponding set-down part. In this regard, the punching knife is pressed, counter to a spring force, using a supporting frame, against the spring frame of the set-down part, and thereby moved out downward, toward the portion container.

The force required for this operation can be derived from various sources. The use of an electrically driven spindle element, a lifting magnet or a piston, which can be activated hydraulically or pneumatically, is particularly preferred. The pressing element of the punching press can be configured to be round or cross-shaped, to some advantage, but can also be logically adapted to the various conceivable shapes of the portion containers, as a function of these shapes.

Aside from the opening position, a covering position is also provided at any desired other location of the apparatus, if necessary even at the same location at which the lid part, which lies on the portion container after punching, is removed. Preferably, a gripping element, a suction element or a magnet can be provided there, with which the lid part can be grasped and lifted in controlled manner.

Also, a waste container can be provided, in which the lid parts can be deposited by the apparatus. In this case, the means for retrieval must be structured in such a manner that they can move over the waste container. Alternatively, one of the holders can also be provided as a waste container or a lid part can also be deposited onto or into one of the portion containers that has already been emptied.

For depositing the lid part into a waste container, the device can have a roll-over arm, preferably one that is electrically operated. This arm is at first inclined over the opened portion container, where the means for retrieval grasp the lid part, and then rises up to a peak point, over which it passes and then bends down over the waste container.

In this regard, it can be practical if the roll-over arm is structured as a ladder frame through which the lid part it holds can be passed. Then the means for retrieval, together with the lid part being held, can be passed through, on the inside, through the ladder frame, instead of increasing the size of the required movement radius toward the outside.

A preferred embodiment provides for placing the apparatus in a housing in which a carousel is provided. This carousel has a plurality of holders, which can be moved in a circle using an electric motor. By taking off an upper housing part, the user gains access to the carousel, so that he/she can place the portion containers into the holders.

To prevent previously-opened portion containers from passing beyond the retrieval position in the field of vision of the pet, which is already standing ready due to the function of the device, the housing opening can optionally be closed off by an access door that opens automatically for the pet after positioning of the portion container from which the lid has just been removed, and that closes before any further movement of the carousel.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows an apparatus according to the invention, having a housing and a product container accommodated in it, containing wet food for a pet;

FIG. 2 shows a carousel accommodated in the housing according to FIG. 1, having multiple product containers and a carriage-guided apparatus for automatic opening of the product containers;

FIG. 3 shows a lateral cross-sectional view through the apparatus according to FIG. 1 in a first embodiment having two roller elements, before the start of the opening process of a product container;

FIG. 4 shows a lateral cross-sectional view according to FIG. 3 during the opening process of a product container;

FIG. 5 shows a perspective cross-sectional view according to FIG. 3 after completion of the opening process of a product container;

FIG. 6 shows a carousel accommodated in the housing according to FIG. 1, in an alternative embodiment with additional clamping tabs for holding the product containers, in a perspective view;

FIG. 7 shows a detail of FIG. 6 with an additionally shown carriage before the start of the opening process of a product container, in a top view from above;

FIG. 8 shows the detail according to FIG. 7 during the opening process of a product container, in a top view from above;

FIG. 9 shows a lateral cross-sectional view through an apparatus according to FIG. 1 in a second embodiment having a roller element and additional clamping tabs on both sides of the product container, before the start of the opening process of the container;

FIG. 10 shows an alternative apparatus according to the invention, having a housing and a housing opening open within it, for access by a pet to an opened portion container, in a perspective representation;

FIG. 11 shows a carousel of the apparatus according to FIG. 10 in a perspective representation;

FIG. 12 shows a set-down part for being set onto a holder of the carousel according to FIG. 11, in a perspective representation;

FIG. 13 shows a punching knife from a set-down part according to FIG. 12 in a perspective representation;

FIG. 14 shows the apparatus according to FIG. 10 without a housing lid, in a perspective representation;

FIG. 15 shows a punching press, which is positioned above a set-down part, in a perspective representation;

FIG. 16 shows the punching press according to FIG. 15, which activates the set-down part, in a perspective representation;

FIG. 17 shows a gripper as a means for retrieval of a removed lid part from a portion container, in a perspective representation;

FIG. 18 shows the gripper according to FIG. 17 after retrieval of the lid part, in a perspective representation;

FIG. 19 shows the gripper according to FIG. 17 after deposit of the lid part in a waste container, in a perspective representation; and

FIG. 20 shows a suction element as an alternative means for retrieval of the removed lid part after its retrieval from a portion container, in a perspective representation.

### DETAILED DESCRIPTION OF PREFERRED EMBODIMENTS

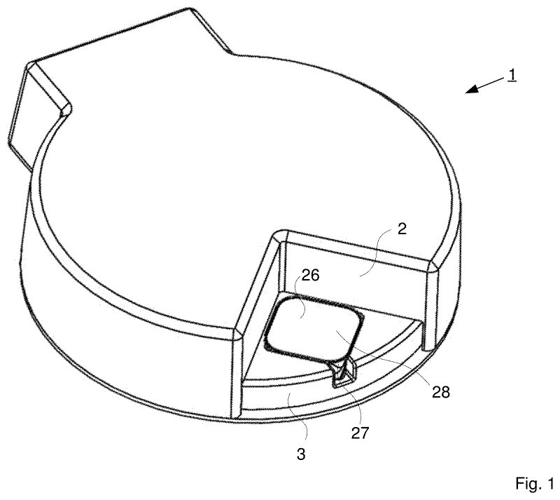

FIG. 1 shows an apparatus for provisioning wet food for pets. This food is generally made available in portion containers 26 by all manufacturers. It is understood that pets cannot open these containers themselves, or at most can open them only with luck and in inadequate manner, so that if it is unavoidable to even leave a pet alone for an extended period of time, the pet must be provided with an opening apparatus for these portion containers 26. Such an apparatus is accommodated in a housing 1, in which a carousel 3 is arranged. This carousel arrangement makes it possible to keep unopened product containers, product containers that might have been opened, but the contents of which have been consumed before they go bad, as well as emptied product containers away from access by the pet. Only one product container 26, currently intended for access, can be accessed from the outside by way of a housing opening 2. A product container 26 should always be arranged in the carousel 3 in such a manner that a tear tab 27 arranged on a lid 28 of the product container 26 can be grasped in straight and good manner, so that the product container 26 can be opened well by the apparatus.

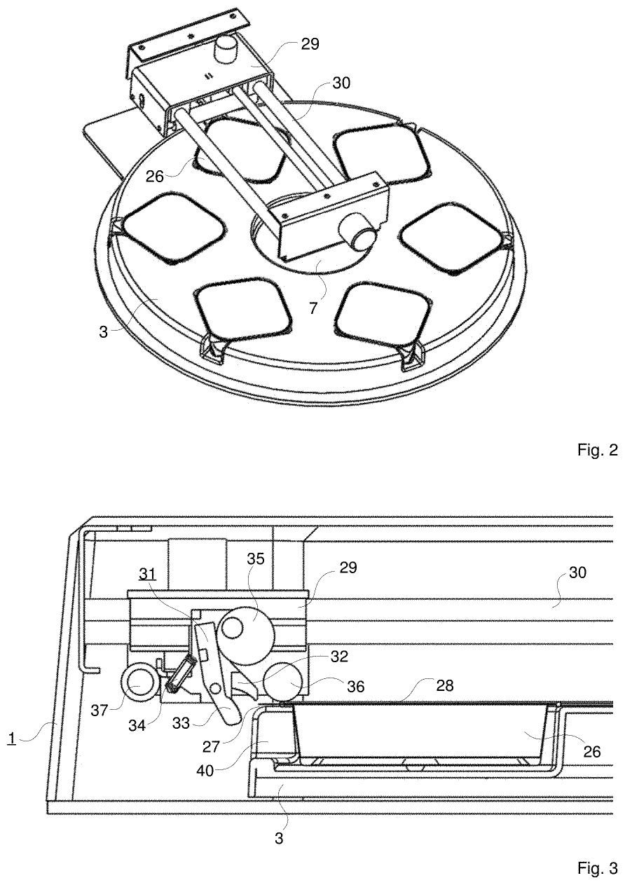

FIG. 2 shows the same arrangement with the housing lid removed. It can be seen that a carriage 29 is arranged in the region that lies opposite the retrieval position, which carriage can be moved along a rail arrangement 30, between a portion container 26 situated there and a waste container 7 centered in the carousel 3.

As shown in FIG. 3, a gripping element 31 is assigned to the carriage 29, which element essentially consists of a first clamping jaw 32 arranged in torque-proof manner, and a second clamping jaw 33, which can pivot about an axis. The clamping surfaces are grooved, so as to obtain a secure hold around the tear tab 27 of a portion container 26 that is accommodated on the carousel 3, which tab is to be gripped. This tear tab 27 is arranged above a recess 40, which allows the gripping element 31 to grasp the tear tab 27 from above and from below. First, a first roller element 36 is assigned to the carriage 29, in its running direction, which element first rolls over the still unopened lid 28 of the product container 26 during movement of the carriage 29 along the rail arrangement 30. The first roller element 36 is followed by the gripping element 31, wherein the two clamping jaws 32 and 33 are at first at a distance from one another. For this purpose, a cam 35 is set in a position of rotation that exerts only a slight or no pressure on the second clamping jaw 33, so that therefore the center of gravity of the cam 35 lies on the side of the cam axis opposite to the second clamping jaw 33. Instead, a pressure spring 34 as a reset element has brought the second clamping jaw 33 into the greatest possible distance from the first clamping jaw 32. A trailing, second roller element 37 follows the gripping element 31 and will subsequently also hold the portion container 26 down, so as to prevent it from being lifted during the course of pulling off the lid.

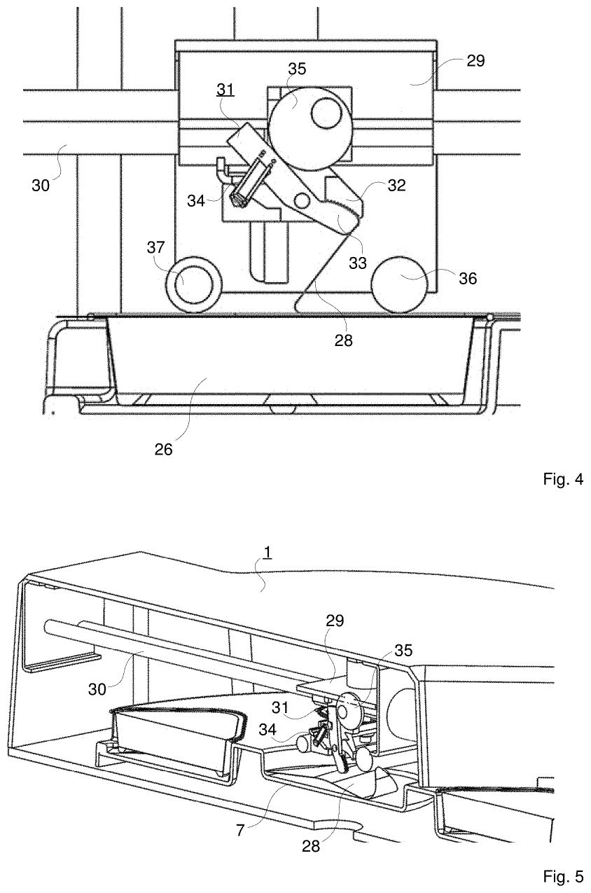

This opening operation in turn is shown in FIG. 4. There the gripping element 31 has already grasped the lid 28 and pulled it partway off the product container 26. For this purpose, the cam 35 was moved into a position in which the second clamping jaw 33 is maximally pressed against the first clamping jaw 32, counter to the force of the pressure spring 34, so that the tear tab 27 is securely held between the clamping jaws 32 and 33. At the same time, the gripping element 31 performs a lift on the carriage 29, so that the removed lid 28 does not get caught up in the trailing second roller element 37, and dirty it.

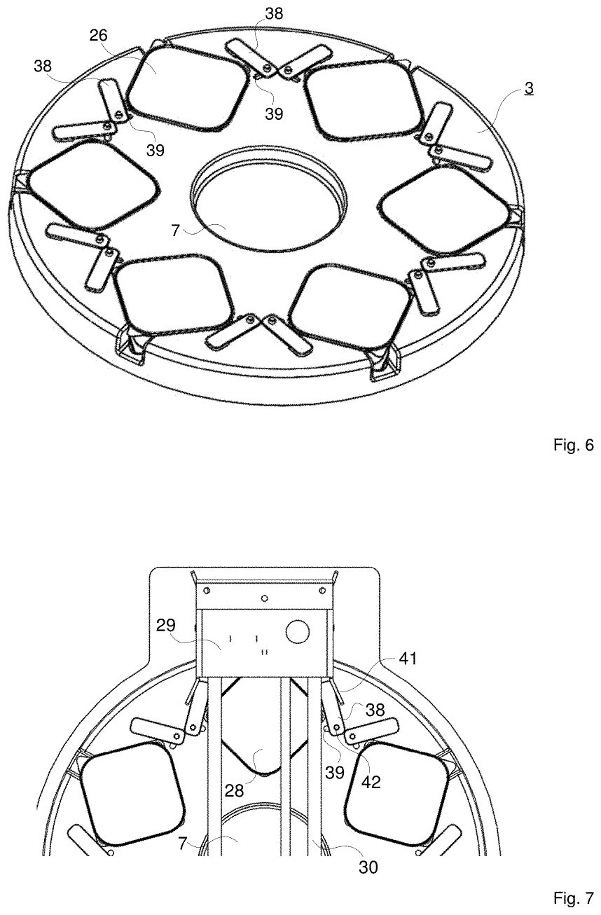

Finally, the carriage 29 reaches an inner position above a waste container 7 centrally situated in the carousel 3, where the cam 35 adjusts the gripping element 31 to an open position, so that the pressure spring 34 can relax again and separate the clamping jaws 32 and 33 from one another. See FIG. 5. The lid 28 of the portion container, which has been removed in the meantime, consequently falls down into the waste container 7, which can be structured to be removable for easier cleaning, if necessary. After the product container 26 has been opened, the carousel 3 is now moved further to such an extent that the opened product container 26 is moved to a position below the housing opening 2 that is accessible to the pet.

FIG. 6 shows an alternative embodiment, in which it is possible to do without a second roller element 37. For this purpose, each product container 26 has two clamping tabs 38 assigned to it, which tabs are attached to the carousel 3 on the side, next to the corresponding product container 26. These tabs are mounted on one side so as to rotate, so that they can be moved between a release position and a clamping position, and hold the portion container 26 in place in the clamping position.

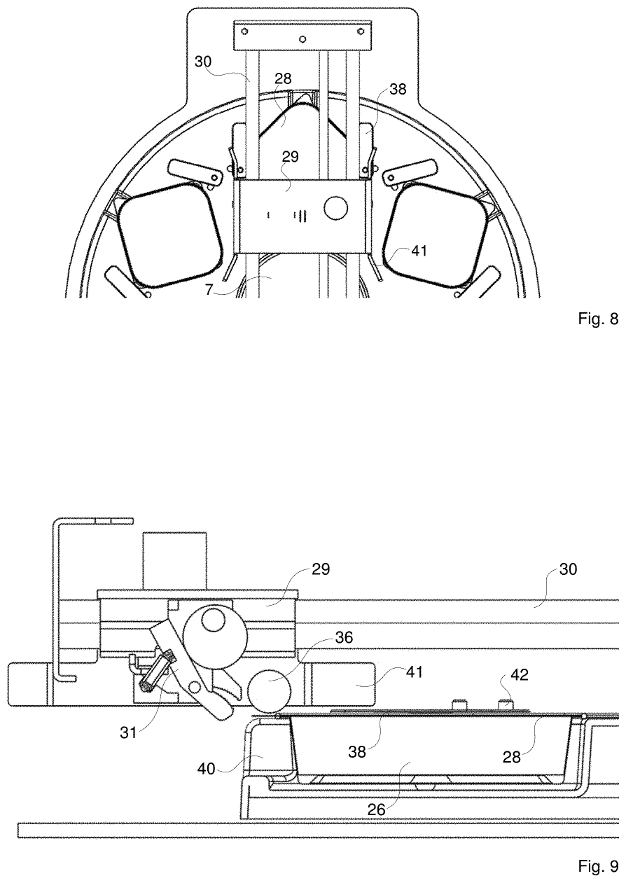

FIGS. 7 and 8 show the movement of the carriage 29 in this alternative embodiment. Here, the carriage 29 has lateral deflectors 41, which bring the clamping tabs 38 into their clamping position during travel of the carriage 29 in the direction of the waste container 7. At their movable end, the clamping tabs have toggles 42 for this purpose, which represent a counterpart to the deflectors 41 on their free top side, while they run in a motion link guide 39 with their underside and limit the movement of the clamping tab 38. After the clamping tabs 38 have passed through the carriage 29, the movable ends of the clamping tabs 38 have moved up against the product container 26 and cover the side edges of the lid 28. The product container is thereby secured to prevent it from being lifted out due to the tension force of the gripping element 31 while the lid 28 is being pulled off.

This process can be shown once again in FIG. 9, in which it can now be seen that the lid 28 of the product container 26 is held using the clamping tabs 38, and that a trailing, second roller element 37 has been eliminated. It can also be seen that the deflectors 41 are structured as angled-away surface elements that interact with the raised toggles 42, while they are pushed across the clamping tabs 38 themselves.

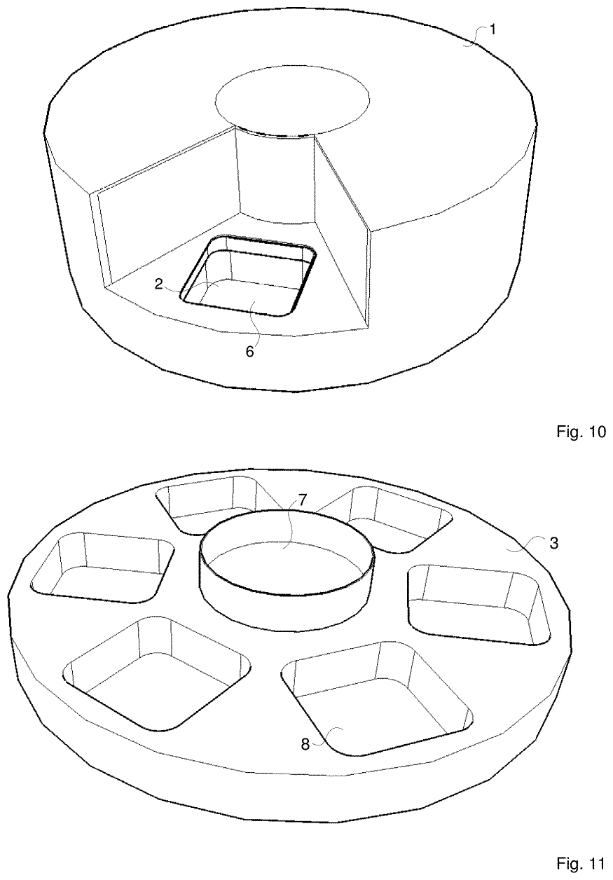

FIG. 10 shows an alternative apparatus for provisioning of wet food for pets. This apparatus is also shielded from the outside, to prevent access by the pet, by a housing 1, which keeps a housing opening 2 clear at an easily accessible location, through which opening a portion container containing wet food can be accessed. Multiple portion containers are stored in a carousel 3 (see FIG. 11), which can move to multiple rotation positions 4, 5, 6 (see FIG. 14), wherein a retrieval position 6 is situated below the housing opening 2. If necessary, the housing opening 2 can be closed off with a door, which is pushed in front of the housing opening 2 during rotation of the carousel 3 and is opened only when a portion container that has just been opened has arrived at the retrieval position 6. Vice versa, any food residues that have not been used and remain in other portion containers that are at different rotation positions in the carousel 3 are removed from access to the pet, so that there is no risk that the pet will eat this old food, which might already be spoiled.

Rotation of the carousel takes place on the basis of an electric motor that is driven by a control unit. In this regard, the control unit also comprises means for programming a program with which the portion containers are made accessible in time-controlled manner and also removed again as part of this process.

FIG. 11 shows the carousel 3, which is mounted in the housing 1 so as to rotate about a central axis of rotation, driven by a motor. In this regard, the carousel 3 has a plurality of holders 8, which are distributed along the circumference of the carousel 3. A waste container 7 is arranged centrally in the region of the axis of rotation, in which container lids removed from the portion containers are deposited. When the empty portion containers are replaced with full ones, the waste container 7 can also be emptied.

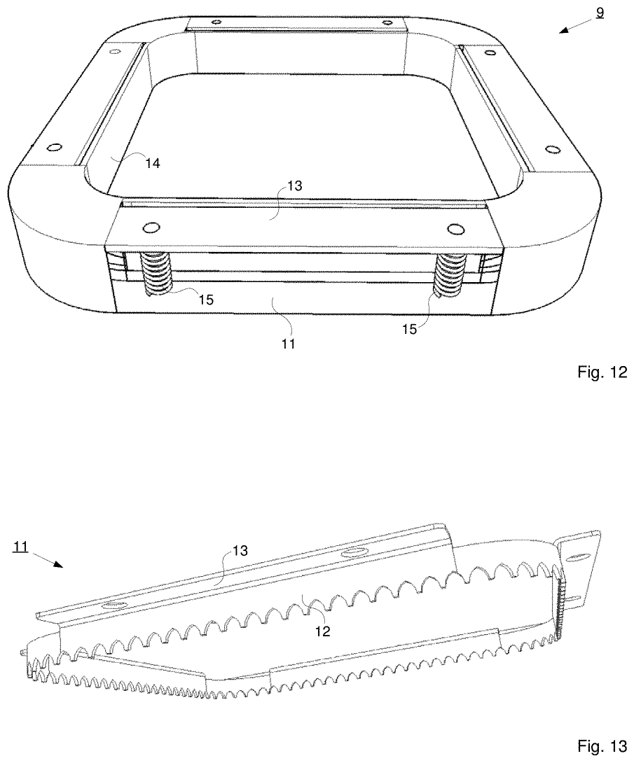

FIG. 12 shows a set-down part 9, which is set down, after a portion container has been set into a holder 8, onto the container or onto the edge of the holder 8. The drawings proceed from a square shape of the product container, which has rounded corners. Analogously, however, other shapes can be implemented in the same manner.

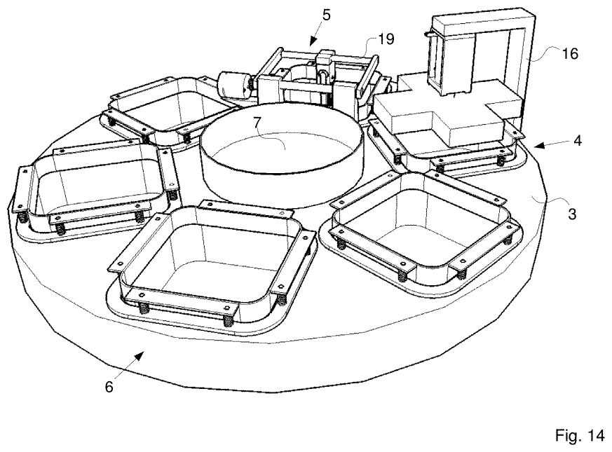

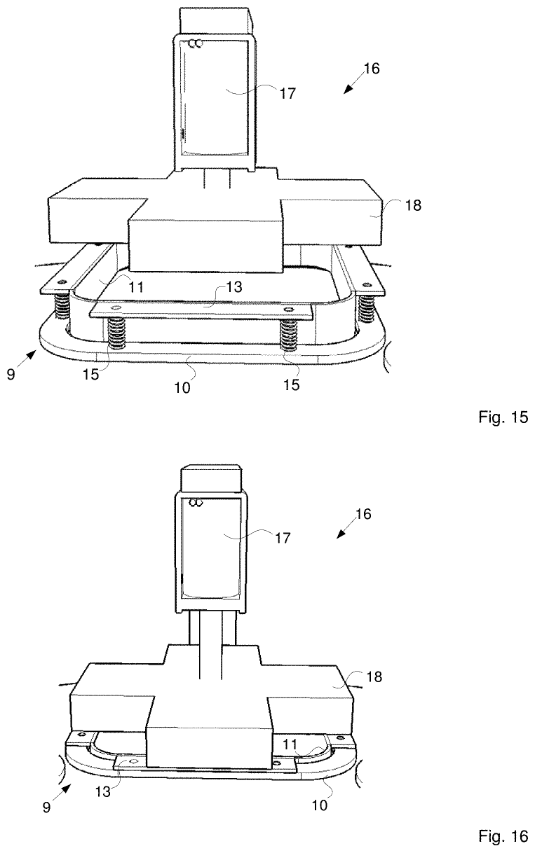

The base of the set-down part 9 is a spring frame 10 (see FIG. 15), relative to which a punching knife 11 having a formed-on spring support 13, as shown in the subsequent FIG. 13, is supported. Springs 15 are arranged between the spring support 13 and the spring frame 10, so that the punching knife 11 springs back into the starting position shown in FIG. 12 after activation by means of pressure from above. A shield 14 is provided on the inner side of the punching knife 11, which shield covers the blade 12 of the punching knife 11, so that there is no risk of injury on the part of the pet. The shield 14 furthermore serves as a structural element of the set-down part 9 and produces a firm frame that is not hazardous for the pet. The entire set-down part 9 can be easily removed and can therefore be cleaned well.

FIG. 13 shows the punching knife 11 laid into the set-down part 9, which knife essentially consists of a circumferential blade 12, closed in itself, which runs circumferentially, and possesses a spring support 13, in each instance, at the four outer edges. By way of these supports, the punching knife 11 is uniformly pressed downward and first drills into the lid of a portion container with tips distributed over the blade 12, wherein concave blade sections arranged between the tips shear off the lid material after it is first penetrated, until the lid remains lying loosely on the portion container as a lid part.

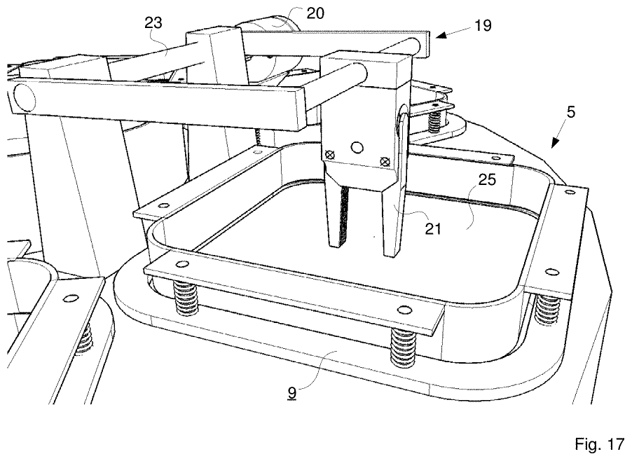

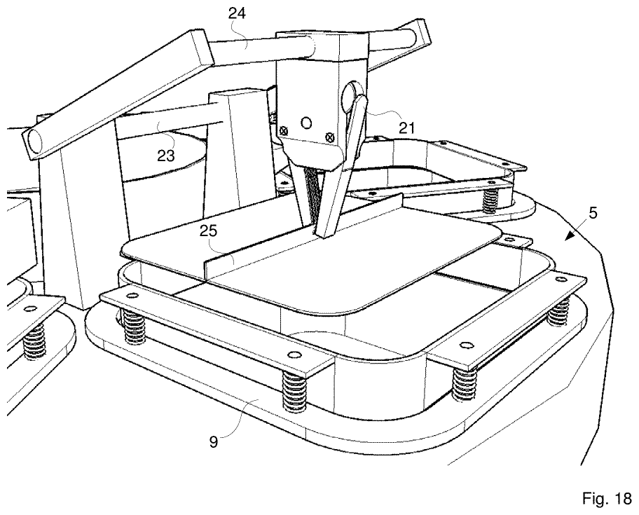

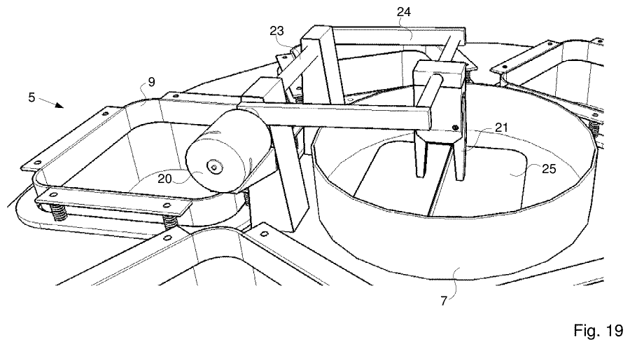

FIG. 14 shows the complete carousel 3 in an overview, wherein the punching process just described takes place at an opening position 4. There, a punching press 16 is installed, fixed in place in the housing 1, below and through which press the carousel 3 can rotate. An uncovering device 19 is situated in a uncovering position 5, which device lifts the lid of the portion container, referred to as lid part 25 hereinafter (see FIG. 17), from the portion container after it has been removed by the punching process, and brings it to a waste container 7 that stands centrally in the interior of the carousel 3. After the portion container is uncovered, it is moved to the retrieval position 6, where the pet can access the content of the portion container through the housing opening 2.

FIGS. 15 and 16 show the punching process, during which a pressing element 18, here a cross-shaped pressing punch, presses onto the spring support 13 of the set-down part 9 positioned underneath it, using a spindle drive 17. As a result, the punching knife 11 is pressed downward counter to the spring force of the springs 15. In the simplified representation of FIGS. 6 and 7, an inside shield 14 is eliminated. If such a shield is to be used, as shown in FIG. 12, the pressing element 18 must be equipped with feet in the end position, so that the shield 14 can be circumvented when pressure is exerted on the spring supports 13 of the punching knife 11. Due to this design, the parts of the punching press 16 do not come into contact with the content of the portion containers, so that the required cleaning is limited to the set-down parts 9 and their individual parts.

The pressed-in punching knife 11 presses into the lid of the portion container, wherein the shape of the punching knife 11 is adapted to the shape of the portion container. Therefore, the lid is cut off along an outer wall of the portion container and remains lying on the portion container, which is still filled, as a lid part 25. In this situation, the carousel 3 is then moved into the uncovering position 5, in which the lid part 25 is removed from the portion container.

This operation is shown in FIGS. 17 to 20, in which the portion container being considered is situated in the uncovering position 5 together with the released lid part 25. The set-down part 9 is still laid onto the edge of the holder 8. In order to now lift the lid part 25 off the product container, an uncovering device 19 is used, which has a gripping element 21 mounted on a roll-over arm 23. The gripping element 21 drops down, at the free end of the roll-over arm 23, all the way to the surface of the lid part 25, and is grasped by means of closing of the gripping element 21, as shown in FIG. 18. Subsequently, the roll-over arm 23 is rotated, using an electric motor 20, until the gripper 21 hangs over the waste container 7 arranged centrally in the carousel 3. In this position, it is opened, so that the lid part 25 drops down into the waste container 7.

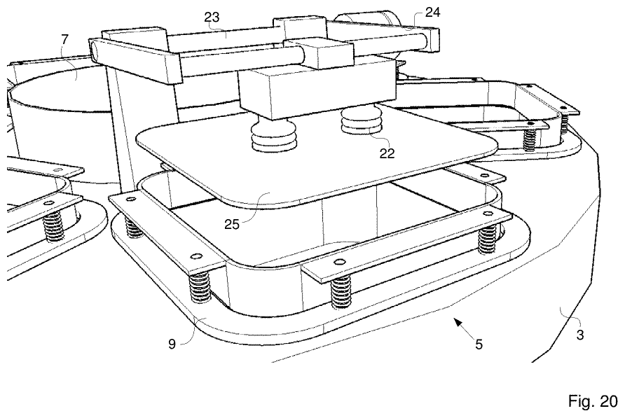

In this regard, the roll-over arm 23 is structured as a ladder frame 24, so that the gripping element 21 with the lid part 25 does not additionally expand the roll-over radius during roll-over, but rather can be held to hang downward. Gripping element 21 and lid part 25 pass through the ladder frame 24, so that the construction height of the housing 1 can be kept as low as possible. FIG. 20 shows a further solution, in which a suction element 22 is used for gripping the cut-off lid part 25.

What has been described above is therefore an apparatus for automatic provisioning of wet food for pets, which allows the use of unopened portion containers, for example in a carousel, but prevents the occurrence of additional sharp edges and keeps a cut-off lid away from access to the pet.

Although only a few embodiments of the present invention have been shown and described, it is to be understood that many changes and modifications may be made thereunto without departing from the spirit and scope of the invention.

What is claimed is:

1. An apparatus for automatic provisioning of wet food for pets comprising
(a) at least one holder for storage of a portion container containing the wet food;
(b) an automatic opener configured to open the portion container situated in the at least one holder;
(c) a rail arrangement traversing the portion container to be opened; and
(d) a carriage movable on the rail arrangement;
wherein the automatic opener comprises a gripping element having first and second clamping jaws movable relative to each other for gripping a tear tab formed on a lid of the portion container; and
wherein the gripping element is accommodated on the carriage.

2. The apparatus according to claim 1, further comprising an activation element and a reset device comprising at least one tension spring or at least one pressure spring;
wherein the first clamping jaw is connected with the carriage in torque-proof manner and the second clamping jaw is pivotable about an axis;
wherein the second clamping jaw is movable using the activation element into a closure position and using the reset device into an open position.

3. The apparatus according to claim 1, wherein the gripping element is mounted on the carriage in height-adjustable manner.

4. The apparatus according to claim 3, wherein the gripping element has a motion link assigned to the gripping element configured to control displacement of the gripping element with regard to a height position of the gripping element and relative movements of the first and second clamping jaws.

5. The apparatus according to claim 2, further comprising a motor drive. wherein the activation element comprises a cam movable by the motor drive.

6. The apparatus according to claim 2, further comprising
a rack having teeth in at least certain sections; and
a gear wheel meshing with the rack;
wherein the activation element comprises a cam connected to interact with the gear wheel in a movement direction of the carriage.

7. The apparatus according to claim 1, wherein the carriage has a first roller element assigned to the carriage and disposed ahead of the carriage in a movement direction, wherein the roller element is configured to press down the portion container.

8. The apparatus according to claim 7, wherein the carriage has a second roller element assigned to the carriage and disposed to trail the carriage in the movement direction, wherein the second roller element is configured to press down the portion container.

9. The apparatus according to claim 7, wherein the at least one holder has first and second sides and releasable clamping elements assigned to the at least one holder on the first and second sides to hold down the portion container accommodated in the at least one holder.

10. The apparatus according to claim 9, further comprising motion link guides or spring elements;
wherein the clamping elements comprise oblong clamping tabs having first and second ends, the first end of each clamping tab being attached in a region of the at least one holder so as to rotate, and a second end of each clamping tab being movable by a respective motion link guide or spring element of the motion link guides or spring elements between a release position and a clamping position.

11. The apparatus according to claim 10, wherein the apparatus comprises motion link guides assigned to the clamping tabs and the carriage has deflector elements configured to move the clamping tabs along the motion link guides from the release position to the clamping position during a movement of the carriage traversing the portion container.

12. The apparatus according to claim 1, further comprising a waste container configured to accommodate the lid after being pulled off the portion container using the gripping element acting on the tear tab;
wherein the carriage is movable between the portion container and the waste container.

13. The apparatus according to claim 1, further comprising an optical device assigned to the carriage or the carousel configured to recognize a gripping position of the tear tab or removal of the lid or a gripping position of the tear tab and removal of the lid; and
a signal device;
wherein in the event of an error, the signal device issues an error signal, an alarm signal, or an error signal and an alarm signal.

14. An apparatus for automatic provisioning of wet food for pets comprising:
(a) at least one holder for storage of a portion container containing the wet food; and
(b) an automatic opener configured to open the portion container situated in the at least one holder;
wherein the automatic opener comprises an endless punching knife having a blade for punching a lid of the portion container; and
wherein the at least one holder has a retrieval device assigned to to the at least one holder configured to retrieve from the portion container a lid part separated from the portion container using the punching knife.

15. The apparatus according to claim 14,
wherein the at least one holder has a set-down part releasably assigned to the at least one holder and comprising a spring frame; and
wherein the punching knife is mounted on the spring frame for movement between a rest position and a punching position.

16. The apparatus according to claim 15, wherein the spring frame has a shield assigned to the spring frame and completely covering the blade of the punching knife in the rest position and at least partially exposing the blade in the punching position.

17. The apparatus according to claim 15, further comprising:
a carousel having an opening position with a punching press assigned to the opening position for activation of the punching knife supported against the spring frame; and
a spindle drive, a lifting magnet, a dropping weight, or a piston;
wherein the punching press has a pressing element assigned to the punching press configured to be activated by way of the spindle drive, the lifting magnet, the dropping weight or the piston.

18. The apparatus according to claim 15, wherein the retrieval device comprises an uncovering device at an uncovering position of the carousel.

19. The apparatus according to claim 1, furthermore comprising
a housing;
a carousel accommodated in the housing; and
an electric motor;
wherein the carousel carries the at least one holder and is rotatable by the electric motor about an axis of rotation between a first position and a retrieval position; and
wherein the housing is configured to allow access from outside the housing at the retrieval position through a housing opening into an interior of the portion container brought to the retrieval position by the carousel.

20. The apparatus according to claim 17,
wherein the at least one holder is configured for shape-fit storage of the portion container;
wherein the punching knife is resiliently mounted to the spring frame; and
wherein the pressing element is configured to be cross-shaped or round.
